(19) United States
(12) Patent Application Publication
(10) Pub. No.: US 2005/0063850 A1
(43) Pub. Date: Mar. 24, 2005

(54) Scroll pump using isolation bellows and synchronization mechanism

(76) Inventors: Anthony G. Liepert, Lincoln, MA (US); Jeffrey C. Warren, Westford, MA (US)

Correspondence Address: Varian Inc.;Legal Department, 3120 Hansen Way D-102, Palo Alto, CA, 94304, US

(21) Appl. No.: 10/666,100

(22) Filed: Sep. 18, 2003

(51) Int. Cl. F03C 2/00; F04C 18/00

(52) U.S. Cl. 418/55.4; 418/55.1

(57) ABSTRACT

Vacuum pumping apparatus includes a scroll set having an inlet and an outlet, the scroll set including a stationary scroll element and an orbiting scroll element, and a drive mechanism for producing orbiting motion of the orbiting scroll element relative to the stationary scroll element. The vacuum pumping apparatus further includes a bellows assembly coupled between a first stationary component of the apparatus and the orbiting scroll element so as to isolate a first volume inside the bellows assembly and a second volume outside the bellows assembly. One end of the bellows assembly is free to rotate during motion of the orbiting scroll element. The apparatus also includes a synchronization mechanism coupled between the orbiting scroll element and a second stationary component of the apparatus. The synchronization mechanism is located within the first volume.

### FIELD OF THE INVENTION

This invention relates to scroll-type vacuum pumps and, more particularly, to scroll-type vacuum pumps which utilize a bellows for isolating the working volume of the pump from the external environment and which utilize one or more synchronization mechanisms for synchronization of orbiting and stationary scroll elements.

### BACKGROUND OF THE INVENTION

Scroll devices are well known in the field of vacuum pumps and compressors. In a scroll device, a movable spiral blade orbits with respect to a fixed spiral blade within a housing. The movable spiral blade is connected to an eccentric drive mechanism. The configuration of the scroll blades and their relative motion traps one or more volumes or “pockets” of a fluid between the blades and moves the fluid through the device. Most applications apply rotary power to pump a fluid through the device. Oil-lubricated scroll devices are widely used as refrigerant compressors. Other applications include expanders, which operate in reverse from a compressor, and vacuum pumps. Scroll pumps have not been widely adopted for use as vacuum pumps, mainly because the cost of manufacturing a scroll pump is significantly higher than a comparably-sized, oil-lubricated vane pump. Dry scroll pumps have been used in applications where oil contamination is unacceptable. A high displacement rate scroll pump is described in U.S. Pat. No. 5,616,015, issued Apr. 1, 1997 to Liepert.

A scroll pump includes stationary and orbiting scroll elements, and a drive mechanism. The stationary and orbiting scroll elements each include a scroll plate and a spiral scroll blade extending from the scroll plate. The scroll blades are intermeshed together to define interblade pockets. The drive mechanism produces orbiting motion of the orbiting scroll element relative to the stationary scroll element so as to cause the interblade pockets to move toward the pump outlet.

Scroll pumps typically utilize one or more devices for synchronizing the intermeshed scroll blades. Each synchronizing device is coupled between the stationary and orbiting scroll elements and is required to permit orbiting movement while preventing relative rotation of the scroll elements. In one prior art approach, three crank mechanisms are connected between the orbiting and stationary scroll elements.

U.S. Pat. No. 5,951,268, issued Sep. 14, 1999 to Pottier et al. and U.S. Pat. No. 6,022,202, issued Feb. 8, 2000 to Pottier et al. disclose scroll pumps which utilize a metal bellows for synchronizing the intermeshed scroll blades. The metal bellows surrounds the crankshaft and is connected to the orbiting scroll element on one end and to a stationary wall at the other end of the crankshaft. Since a metal bellows has a high resistance to torsional deformation, it can be used to prevent rotation of the orbiting scroll element. In addition, the bearings required to support the crankshaft and the motor are isolated by the metal bellows from the working volume of the pump. However, abnormal torsional loads, which occur during startup and when the pump ingests debris, may overstress and possibly cause failure of the metal bellows.

A scroll pump that utilizes a metal bellows for isolation and crank mechanisms for synchronization is disclosed in U.S. Pat. No. 3,802,809, issued Apr. 9, 1974 to Vulliez. The metal bellows has a fixed connection at both ends and thus may be overstressed in the event of abnormal torsional loads as described above. The disclosed design is torsionally overconstrained, and the crank mechanisms may impose torsional loads on the metal bellows. In addition, the crank mechanisms are located outside the periphery of the scroll blades and add substantially to the size of the pump.

Accordingly, there is a need for improved scroll-type vacuum pumping apparatus.

### SUMMARY OF THE INVENTION

According to a first aspect of the invention, vacuum pumping apparatus is provided. The vacuum pumping apparatus comprises a scroll set having an inlet and an outlet, and a drive mechanism operatively coupled to the scroll set. The scroll set comprises a stationary scroll element including a stationary scroll blade and an orbiting scroll element including an orbiting scroll blade. The stationary and orbiting scroll blades are intermeshed together to define one or more interblade pockets. The drive mechanism produces orbiting motion of the orbiting scroll blade relative to the stationary scroll blade so as to cause the one or more interblade pockets to move toward the outlet. The vacuum pumping apparatus further comprises a bellows assembly coupled between a first stationary component of the vacuum pumping apparatus and said orbiting scroll element so as to isolate a first volume inside the bellows assembly and a second volume outside the bellows assembly. One end of the bellows assembly is free to rotate during orbiting motion of the orbiting scroll blade relative to the stationary scroll blade. The vacuum pumping apparatus further comprises a synchronization mechanism coupled between the orbiting scroll element and a second stationary component of the vacuum pumping apparatus. The synchronization mechanism is located within the first volume.

The bellows assembly may comprise a bellows, a first flange sealed to a first end of the bellows and a second flange sealed to a second end of the bellows. The apparatus may further comprise a frame having a center hub, and the first flange may be rotatably connected to the center hub. The second flange may be coupled to the orbiting scroll element. An optional bellows may be sealed between the stationary scroll element and the first flange.

The synchronization mechanism may comprise three synchronization cranks, each coupled between the orbiting scroll element and a mounting plate affixed to the center hub. The synchronization cranks may be located at least partially inside the bellows assembly. Preferably, the synchronization cranks are located within an outer periphery of the stationary and orbiting scroll blades.

According to a second aspect of the invention, a method is provided for operating vacuum pumping apparatus of the type comprising a stationary scroll element and an orbiting scroll element. The method comprises producing orbiting motion of the orbiting scroll element relative to the stationary scroll element, coupling a bellows assembly between a first stationary component of the vacuum pumping apparatus and the orbiting scroll element so as to isolate a first volume inside the bellows assembly and a second volume outside the bellows assembly, wherein one end of the bellows assembly is free to rotate during motion of the orbiting scroll element relative to the stationary scroll element, and coupling a synchronization mechanism between the orbiting scroll element and a second stationary component of the vacuum pumping apparatus so as to synchronize the orbiting scroll element and the stationary scroll element, wherein the synchronization mechanism is located within the first volume.

### BRIEF DESCRIPTION OF THE DRAWINGS

For a better understanding of the present invention, reference is made to the accompanying drawings, which are incorporated herein by reference and in which:

FIG. 1 is a schematic, cross-sectional diagram of a scroll-type vacuum pumping apparatus in accordance with an embodiment of the invention; and

FIG. 2 is a schematic, cross-sectional diagram of the scroll-type vacuum pumping apparatus, taken along the line 2-2 of FIG. 1.

### DETAILED DESCRIPTION OF THE INVENTION

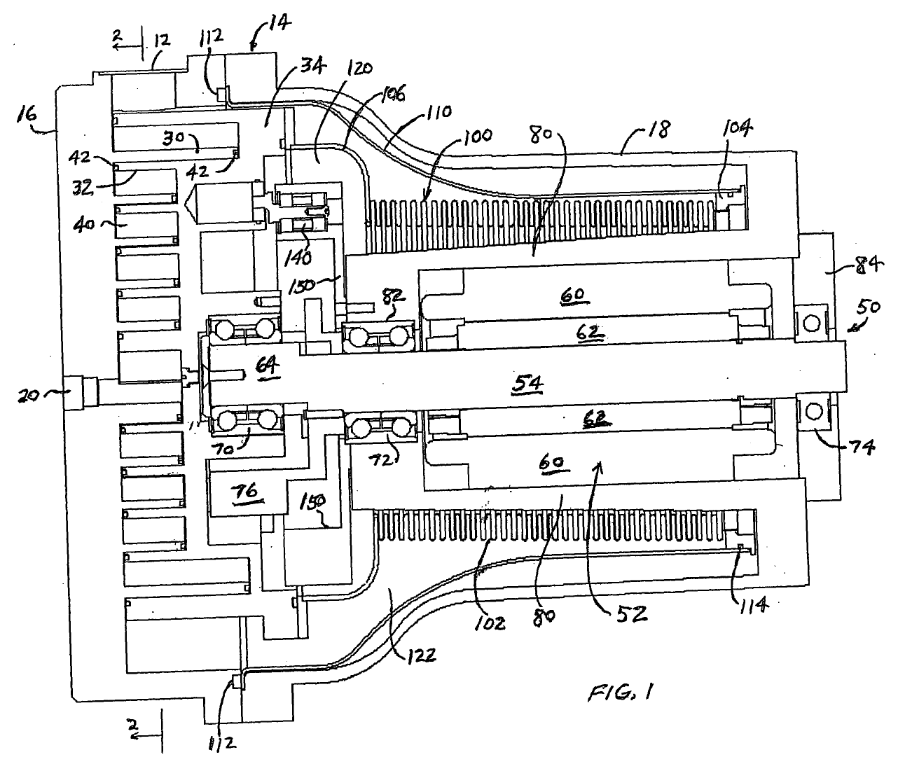

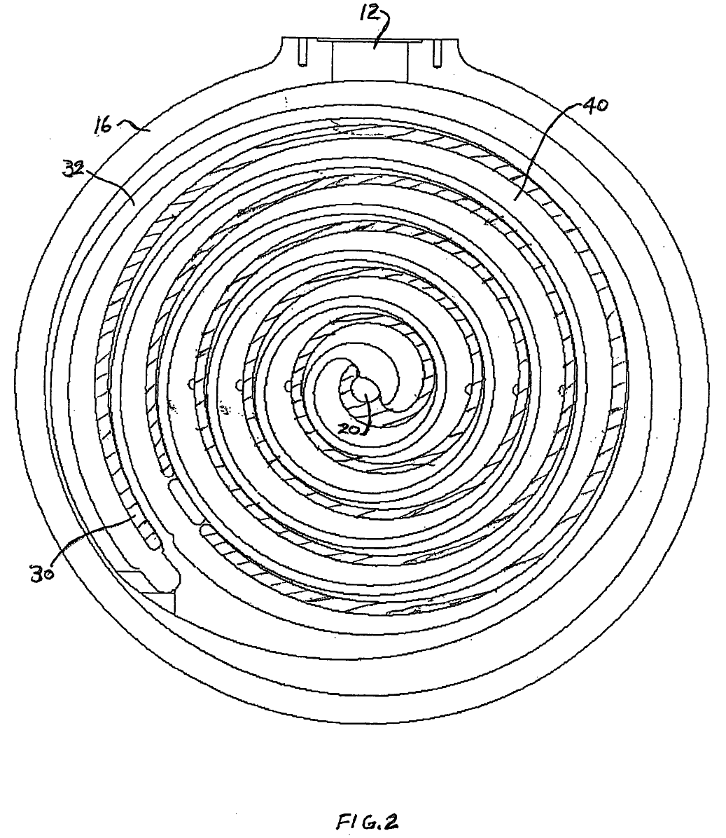

A scroll-type vacuum pump, or scroll pump, in accordance with an embodiment of the invention is shown in FIGS. 1 and 2. A single-ended vacuum pump is shown. A gas, typically air, is evacuated from a vacuum chamber or other equipment (not shown) connected to an inlet 12 of the pump. A pump housing 14 includes a stationary scroll plate 16 and a frame 18. The pump further includes an outlet 20.

The scroll pump includes a set of intermeshed spiral-shaped scroll blades. In FIG. 1, a scroll set includes a stationary scroll blade 30 extending from stationary scroll plate 16 and an orbiting scroll blade 32 extending from an orbiting scroll plate 34. Scroll blades 30 and 32 are preferably formed integrally with scroll plates 16 and 34, respectively, to facilitate thermal transfer and to increase the mechanical rigidity and durability of the pump. Scroll blade 30 and scroll plate 16 constitute a stationary scroll element, and scroll blade 32 and scroll plate 34 constitute an orbiting scroll element. Scroll blades 30 and 32 extend axially toward each other and are intermeshed together to form interblade pockets 40. Tip seals 42 located in grooves at the tips of the scroll blades provide sealing between the scroll blades. Orbiting motion of scroll blade 32 relative to scroll blade 30 produces a scroll-type pumping action of the gas entering the interblade pockets 40 between the scroll blades.

A drive mechanism 50 for the scroll pump includes a motor 52 coupled through a crankshaft 54 to orbiting scroll plate 34. Motor 52 includes a stator 60 and a rotor 62, which is affixed to crankshaft 54. An end 64 of crankshaft 54 has an eccentric configuration with respect to the main part of crankshaft 54 and is mounted to orbiting scroll plate 34 through an orbiting plate bearing 70. Crankshaft 54 is mounted to pump housing 14 through a main bearing 72 and a rear bearing 74. Counterweight 76 affixed to crankshaft 54 provides balanced operation of the vacuum pump. When motor 52 is energized, crankshaft 54 rotates in bearings 72 and 74. The eccentric configuration of crankshaft end 64 produces orbiting motion of scroll blade 32 relative to scroll blade 30, thereby pumping gas from inlet 12 to outlet 20.

The frame 18 includes a reentrant center hub 80 which extends inwardly toward scroll blades 30 and 32 and which defines a cavity for receiving motor 52 and crankshaft 54. Center hub 80 defines a bore 82 for mounting main bearing 72. An end plate 84 covers the cavity defined by center hub 80 and serves as a mounting element for rear bearing 74.

The scroll pump further includes a bellows assembly 1 00 coupled between a first stationary component of the vacuum pump and the orbiting scroll plate 34 so as to isolate a first volume inside bellows assembly 100 and a second volume outside bellows assembly 100. One end of bellows assembly 100 is free to rotate during motion of the orbiting scroll blade 32 relative to the stationary scroll blade 30. As a result, the bellows assembly 100 does not synchronize the scroll blades and is not subjected to significant torsional stress during operation.

In the embodiment of FIGS. 1 and 2, bellows assembly 100 includes a bellows 102, a first flange 104 sealed to a first end of bellows 102 and a second flange 106 sealed to a second end of bellows 102. Flange 104 may be in the form of a ring that is rotatably mounted on center hub 80. Flange 106 may have a bell shape or flared shape for fixed attachment to orbiting scroll plate 34.

Bellows assembly 100 is coupled between center hub 80 (the first stationary component) and orbiting scroll plate 34. In the embodiment of FIGS. 1 and 2, bellows assembly 100 has a fixed connection to orbiting scroll plate 34 and a rotatable connection to center hub 80. However, the fixed and rotatable connections can be reversed within the scope of the invention.

The scroll pump may further include an optional bellows can 110 coupled between housing 14 and first flange 104. Bellows can 110 may have a tubular shape of variable diameter. One end of bellows can 110 may be secured between frame 18 and stationary scroll plate 16 and may be sealed by an elastomer ring 112. The other end of bellows can 110 may be rotatably coupled to first flange 104 and sealed thereto with an elastomer ring 114. Thus, flange 104 is free to rotate between bellows can 110 and center hub 80. Bellows can 110 relaxes the requirement for frame 18 to be hermetically sealed.

Bellows assembly 100 provides isolation between a first volume inside bellows assembly 100 and a second volume outside bellows assembly 100. In the embodiment of FIG. 1, a volume 120 inside bellows assembly 100 is in gas communication with the external environment, typically atmospheric pressure, and a working volume 122 between bellows assembly 100 and bellows can 110 is at or near the vacuum pressure of pump inlet 12. It may be observed that motor 52, crankshaft 54 and bearings 70, 72 and 74 are located within the first volume 120 defined by bellows assembly 100 and are isolated from working volume 122 of the vacuum pump. As a result, the risk of contamination of working volume 122 from components of the drive mechanism is limited.

The characteristics of bellows 102 are selected to permit orbiting motion of scroll plate 34 while maintaining isolation between volumes 120 and 122. The bellows 102 may be fabricated of any material that permits lateral deflection to accommodate orbiting motion while having sufficient durability to maintain vacuum isolation over an extended operating life. Suitable materials include metals, plastics and reinforced rubber. A preferred material is 321 stainless steel. For a vacuum scroll pump with a crank offset of 6 mm (millimeters), a bellows geometry that attains infinite flexural life has a bellows outside diameter of 134 mm, a bellows inside diameter of 113 mm, 30 convolutions with a pitch of 5.5 mm, and a material thickness of 0.2 mm.

The scroll pump further includes a synchronization mechanism coupled between orbiting scroll plate 34 and a stationary component of the vacuum pump. In the embodiment of FIGS. 1 and 2, the synchronization mechanism includes a set of three synchronization cranks, each coupled between orbiting scroll plate 34 and a second stationary component of the vacuum pump. In FIG. 1, a synchronization crank 140 is shown. Synchronization crank 140 and two additional synchronization cranks (not shown) are equally spaced from crankshaft 54 and are equally spaced with respect to each other. In the embodiment of FIGS. 1 and 2, a mounting plate 150 is secured to center hub 80, and the stationary ends of the synchronization cranks are connected to mounting plate 150 (the second stationary component). The synchronization cranks may be of standard configuration as known in the scroll pump art.

In the embodiment of FIGS. 1 and 2, synchronization crank 140 and the two additional synchronization cranks are located within the volume 120 defined by bellows assembly 100 which is isolated from working volume 122. Thus, the synchronization cranks are isolated from working volume 122, and the risk of contamination is limited. In addition, synchronization crank 140 and the two additional synchronization cranks are located at least partially within bellows assembly 100. Furthermore, because the synchronization cranks are located a relatively short distance from crankshaft 54, within the outer periphery of scroll blades 30 and 32, a compact scroll pump is provided.

In operation, motor 52 is energized to cause rotation of crankshaft 54 and orbiting motion of scroll plate 34 relative to scroll plate 16. The orbiting motion causes interblade pockets 40 to move from inlet 12 toward outlet 20, thereby pumping fluid from a vacuum chamber attached to inlet 12. Because bellows assembly 100 has a fixed connection to orbiting scroll plate 34 through flange 106, bellows assembly 100 is subjected at one end to orbiting motion. As noted above, bellows assembly 100 is free to rotate relative to center hub 80 via the rotatable connection of flange 104. Thus, bellows assembly 100 performs an isolation function between pump volumes 120 and 122, but does not perform a synchronization function. As a result, bellows 102 is not subjected to high torsional loads and an infinite operating life can be achieved. Synchronization of scroll blades 30 and 32 is performed by the synchronization cranks. Potential sources of contamination, including motor 52, crankshaft 54, bearings 70, 72 and 74 and the synchronization cranks, are isolated from the working volume 122 of the scroll pump, thereby substantially reducing the risk of contamination of the vacuum chamber connected to inlet 12.

Having thus described the inventive concepts and a number of exemplary embodiments, it will be apparent to those skilled in the art that the invention may be implemented in various ways, and that modifications and improvements will readily occur to such persons. Thus, the examples given are not intended to be limiting, and are provided by way of example only. The invention is limited only as required by the following claims and equivalents thereto.

1. Vacuum pumping apparatus comprising:
a scroll set having an inlet and an outlet, said scroll set comprising a stationary scroll element including a stationary scroll blade and an orbiting scroll element including an orbiting scroll blade, wherein said stationary and orbiting scroll blades are intermeshed together to define one or more interblade pockets;
a drive mechanism operatively coupled to said orbiting scroll element for producing orbiting motion of said orbiting scroll blade relative to said stationary scroll blade so as to cause said one or more interblade pockets to move toward said outlet;
a bellows assembly coupled between a first stationary component of said vacuum pumping apparatus and said orbiting scroll element so as to isolate a first volume inside the bellows assembly and a second volume outside the bellows assembly, wherein one end of said bellows assembly is free to rotate during motion of said orbiting scroll blade relative to said stationary scroll blade; and
a synchronization mechanism coupled between said orbiting scroll element and a second stationary component of said vacuum pumping apparatus and located within the first volume.

2. Vacuum pumping apparatus as defined in claim 1, wherein the bellows assembly comprises a bellows, a first flange sealed to a first end of the bellows and a second flange sealed to a second end of the bellows.

3. Vacuum pumping apparatus as defined in claim 2, further comprising a frame having a center hub, wherein the first flange is rotatably connected to the center hub.

4. Vacuum pumping apparatus as defined in claim 3, wherein the second flange is coupled to the orbiting scroll element.

5. Vacuum pumping apparatus as defined in claim 4, further comprising a bellows can sealed between the stationary scroll element and the first flange.

6. Vacuum pumping apparatus as defined in claim 2, wherein the bellows comprises a metal bellows.

7. Vacuum pumping apparatus as defined in claim 1, wherein the drive mechanism comprises a motor mounted at least partially inside the bellows assembly.

8. Vacuum pumping apparatus as defined in claim 4, wherein the synchronization mechanism comprises three synchronization cranks, each coupled between said orbiting scroll element and a mounting plate affixed to the center hub.

9. Vacuum pumping apparatus as defined in claim 8, wherein the synchronization cranks are located at least partially inside the bellows assembly.

10. Vacuum pumping apparatus as defined in claim 8, wherein the synchronization cranks are located within an outer periphery of the stationary and orbiting scroll blades.

11. Vacuum pumping apparatus as defined in claim 1, wherein the bellows assembly is configured to define a volume outside the bellows assembly that is isolated from the external environment and is configured to limit torsional stress on the bellows assembly during orbiting motion of said orbiting scroll blade relative to said stationary scroll blade.

12. A method for operating vacuum pumping apparatus of the type comprising a stationary scroll element and an orbiting scroll element, said method comprising:
producing orbiting motion of said orbiting scroll element relative to said stationary scroll element;
coupling a bellows assembly between a first stationary component of the vacuum pumping apparatus and the orbiting scroll element so as to isolate a first volume inside the bellows assembly and a second volume outside the bellows assembly, wherein one end of said bellows assembly is free to rotate during motion of said orbiting scroll element relative to said stationary scroll element; and
coupling a synchronization mechanism between said orbiting scroll element and a second stationary component of the vacuum pumping apparatus so as to synchronize said orbiting scroll element and said stationary scroll element, wherein the synchronization mechanism is located within the first volume.

13. The method as defined in claim 12, wherein coupling the bellows assembly comprises providing a bellows, sealing a first flange to a first end of the bellows and sealing a second flange to a second end of the bellows.

14. The method as defined in claim 13, wherein the vacuum pumping apparatus includes a frame having a center hub and wherein coupling the bellows assembly comprises rotatably connecting the first flange to the center hub.

15. The method as defined in claim 14, wherein coupling the bellows assembly comprises coupling the second flange to the orbiting scroll element.

16. The method as defined in claim 15, wherein coupling the bellows assembly further comprises sealing a bellows can between the stationary scroll element and the first flange.

17. The method as defined in claim 12, wherein coupling the synchronization mechanism comprises locating the synchronization mechanism at least partially inside the bellows assembly.

18. The method as defined in claim 12, wherein coupling the synchronization mechanism comprises locating the synchronization mechanism within an outer periphery of the stationary and orbiting scroll elements.

19. The method as defined in claim 12, wherein coupling the bellows assembly comprises configuring the bellows assembly to define a volume outside the bellows assembly that is isolated from the external environment and to limit torsional stress on the bellows assembly during orbiting motion of the orbiting scroll element relative to the stationary scroll element.
